(19) United States
(12) Patent Application Publication
(10) Pub. No.: US 2019/0180704 A1
(43) Pub. Date: Jun. 13, 2019

(54) DISPLAY APPARATUS AND DRIVING METHOD OF DISPLAY PANEL

(71) Applicant: Au Optronics Corporation, Hsinchu (TW)

(72) Inventors: Mei-Chun Cheng, Hsinchu (TW); Zun-Yu Wang, Hsinchu (TW); Chia-Chu Wang, Hsinchu (TW); Yi-Ping Huang, Hsinchu (TW); Hao-Ren Gu, Hsinchu (TW); Tzu-Han Fang, Hsinchu (TW)

(73) Assignee: Au Optronics Corporation, Hsinchu (TW)

(21) Appl. No.: 15/970,900

(22) Filed: May 4, 2018

(30) Foreign Application Priority Data
Dec. 12, 2017 (TW) 106143587

(51) Int. Cl. G09G 3/36

(52) U.S. Cl. CPC G09G 3/3614; G09G 2320/0242; G09G 2320/0209

(57) ABSTRACT

A display apparatus and a driving method of a display panel are provided. A display driver drives the display panel so that the adjacent pixels in each of first display segments and each of the second display segments on a scan line have opposite polarities, and two pixels located on junction section of adjacent first display segment and second display segment have the same polarity.

### CROSS-REFERENCE TO RELATED APPLICATION

This application claims the priority benefit of Taiwan application serial no. 106143587, filed on Dec. 12, 2017. The entirety of the above-mentioned patent application is hereby incorporated by reference herein and made a part of this specification.

### BACKGROUND

### Technical Field

The disclosure relates to an electronic apparatus, and particularly relates to a display apparatus and a driving method of a display panel.

### Description of Related Art

In order to cope with the requirements of high speed, high performance, and design features of lightness, slimness, shortness and smallness on modern products, various electronic components are positively developed towards a trend of miniaturization in volume. Various portable electronic devices have also become a mainstreams, for example, notebooks, cell phones, electronic dictionaries, personal digital assistants (PDA), web pads, tablet personal computers, etc. Regarding an image display panel of a portable electronic device, in order to cope with the demand of miniaturization of the product, liquid crystal display panels having advantages of high spatial usage rate, high image quality, low power consumption, no irradiation, etc. have been widely used.

A rotation direction of liquid crystal is related to an electric field applied to the liquid crystal, and in order to eliminate a direct current (DC) residual voltage stored in the liquid crystal and avoid polarization of the liquid crystal, the liquid crystal may be driven in a way of polarity inversion, namely, driving voltages of different polarities (for example, a positive polarity and a negative polarity) may be alternately provided to pixels in different frame periods. The driving methods of polarity inversion include column inversion, row inversion, frame inversion and dot inversion.

In the driving methods of polarity inversion, the liquid crystal display apparatus driven in the way of dot inversion may have better display quality. However, in the conventional dot inversion driving method, a situation that a voltage level of a common voltage is shifted to one of the polarities is occurred, which results in the display image has a color shift and crosstalk phenomenon, and thus the display quality of the liquid crystal display panel is decreased.

### SUMMARY

The disclosure is directed to a display apparatus and a driving method of a display panel, which are adapted to effectively improve display quality of the display apparatus.

The disclosure provides a display apparatus including a display panel and a display driver. The display panel has a plurality of scan lines, a plurality of data lines and a plurality of pixels arranged in an array, and a pixel region on each of the scan lines is divided into a tail display segment, a plurality of first display segments, a plurality of second display segments and a third display segment, wherein the tail display segment is located at an end of the corresponding scan line, the first display segments and the second display segments other than the tail display segment and the third display segment are alternately arranged on the corresponding scan line, and each of the first display segments and each of the second display segments respectively includes 16 pixels. The display driver is coupled to the display panel to provide a plurality of driving signals to the display panel, so that adjacent pixels in the tail display segment, each of the first display segments, each of the second display segments and the third display segment have opposite polarities, and two pixels located on a junction section of adjacent first display segment and second display segment have the same polarity.

In an embodiment of the disclosure, each of the pixels includes three sub-pixels, and the adjacent sub-pixels have opposite polarities.

In an embodiment of the disclosure, a sum of the sub-pixels included in the tail display segment and the third display segment is equal to a sum of the sub-pixels included in one first display segment and one second display segment.

In an embodiment of the disclosure, the numbers of the sub-pixels included in the tail display segment, each of the first display segments, each of the second display segments and the third display segment are the same.

In an embodiment of the disclosure, on each of the scan lines, the number of the first display segments is equal to the number of the second display segments.

In an embodiment of the disclosure, the numbers of the sub-pixels included in each of the first display segments and each of the second display segments are the same.

The disclosure further provides a driving method of a display panel, wherein the display panel has a plurality of scan lines, a plurality of data lines and a plurality of pixels arranged in an array, the driving method of the display panel includes following steps. A pixel region on each of the scan lines is divided into a tail display segment, a plurality of first display segments, a plurality of second display segments and a third display segment, wherein the tail display segment is located at an end of the corresponding scan line, the first display segments and the second display segments other than the tail display segment and the third display segment are alternately arranged on the corresponding scan line, and each of the first display segments and each of the second display segments respectively includes 16 pixels. A plurality of driving signals is provided to the display panel, so that the adjacent pixels in the tail display segment, each of first display segments, each of the second display segments and the third display segment have opposite polarities, and two pixels located on a junction section of adjacent first display segment and second display segment have the same polarity.

In an embodiment of the disclosure, each of the pixels includes three sub-pixels, and the adjacent sub-pixels have opposite polarities.

In an embodiment of the disclosure, a sum of the sub-pixels included in the tail display segment and the third display segment is equal to a sum of the sub-pixels included in one first display segment and one second display segment.

In an embodiment of the disclosure, the numbers of the sub-pixels included in the tail display segment, each of the first display segments, each of the second display segments and the third display segment are the same.

In an embodiment of the disclosure, on each of the scan lines, the number of the first display segments is equal to the number of the second display segments.

In an embodiment of the disclosure, the numbers of the sub-pixels included in each of the first display segments and each of the second display segments are the same.

According to the above description, the display driver of the embodiment of the disclosure is adapted to drive the display panel so that the adjacent pixels in each of first display segments and each of the second display segments have opposite polarities, and two pixels located on a junction section of adjacent first display segment and second display segment have the same polarity. In this way, the color shift and crosstalk phenomenon occurred in the display image is effectively avoided, and the display quality of the liquid crystal display panel is improved.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a display apparatus according to an embodiment of the disclosure.

FIG. 2 is an example of polarities of corresponding pixels when a scan line on a display panel is driven according to an embodiment of the disclosure.

FIG. 3A-FIG. 3C are image display diagrams of testing a display apparatus by using test patterns of DMW2-47.

FIG. 4A-FIG. 4C are image display diagrams of testing the display apparatus by using test patterns of DMW10-47.

FIG. 5 is an example of polarities of corresponding pixels when a scan line on the display panel is driven according to another embodiment of the disclosure.

FIG. 6 is a flowchart illustrating a driving method of a display panel according to an embodiment of the disclosure.

### DESCRIPTION OF EMBODIMENTS

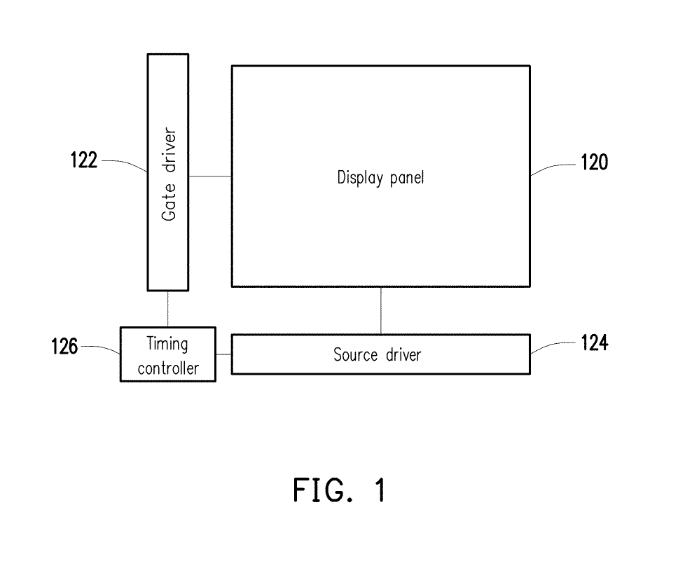

FIG. 1 is a schematic diagram of a display apparatus according to an embodiment of the disclosure. Referring to FIG. 1, the display apparatus includes a display panel 120 and a display driver, the display driver, for example, includes a gate driver 122, a source driver 124 and a timing controller 126. The display panel 210 has a plurality of pixels arranged in an array, the gate driver 122 and the source driver 124 are coupled to the display panel 120, and respectively provide driving signals to the display panel 120, so as to drive scan lines and data lines on the display panel 120 through the driving signals to display a desired image. The timing controller 126 is coupled to the gate driver 122 and the source driver 124, and provides a control signal to control the gate driver 122 and the source driver 124 to generate the driving signals.

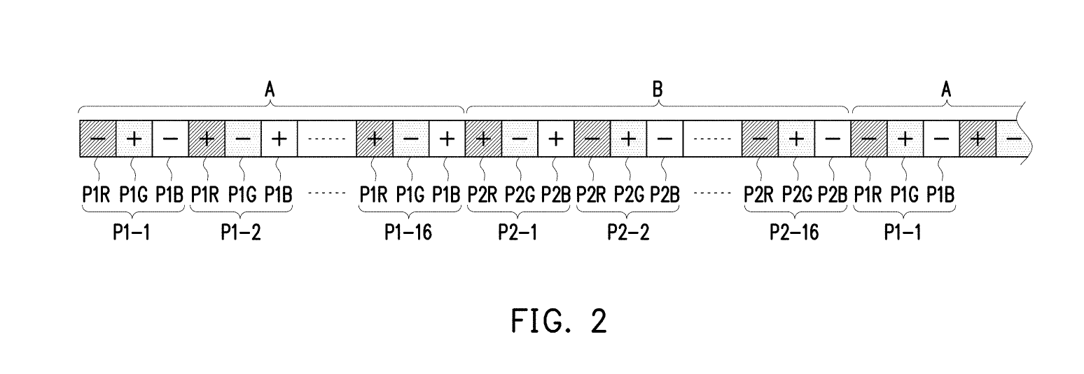

Referring to FIG. 1 and FIG. 2, FIG. 2 is an example of polarities of the corresponding pixels when a scan line on the display panel 120 is driven. In FIG. 2, the pixels corresponding to the scan line is divided into a plurality of first display segments A and a plurality of second display segments B, where each of the first display segments A and each of the second display segments B are alternately arranged along the scan line. Namely, in FIG. 2, the first display segment A, the second display segment B, the first display segment A, the second display segment B . . . are sequentially arranged from the left to the right. In the present embodiment, the number of the first display segments A on the scan line is equal to the number of the second display segments B, though the disclosure is not limited thereto.

Each of the first display segments A and each of the second display segments B respectively include 16 pixels, as shown in FIG. 2, the first display segment A includes 16 pixels P1-1˜P1-16, the second display segment B includes 16 pixels P2-1˜P2-16. The driving signals provided by the gate driver 122 and the source driver 124 make the adjacent pixels in each of first display segments A and each of the second display segments B to have opposite polarities, and the two pixels located on a junction section of the adjacent first display segment A and second display segment B have the same polarity. For example, in the present embodiment, the pixels P1-1˜P1-16 in the first display segment A respectively include three sub-pixels P1R, P1G and P1B, where the sub-pixels P1R, P1G and P1B are respectively used for displaying a red color, a green color and a blue color, and any two adjacent pixels have opposite polarities and any two adjacent sub-pixels in each of the pixels have opposite polarities. For example, the polarities of the sub-pixels P1R, P1G and P1B in the pixel P1-1 are respectively negative, positive, negative, and the polarities of the sub-pixels P1R, P1G and P1B in the pixel P1-2 adjacent to the pixel P1-1 are respectively positive, negative, positive.

Similarly, in the second display segment B, the pixels P2-1˜P2-16 respectively include three sub-pixels P2R, P2G and P2B, where the sub-pixels P2R, P2G and P2B are respectively used for displaying the red color, the green color and the blue color, and any two adjacent pixels have opposite polarities and any two adjacent sub-pixels in each of the pixels have opposite polarities. For example, the polarities of the sub-pixels P2R, P2G and P2B in the pixel P2-1 are sequentially positive, negative, positive, and the polarities of the sub-pixels P2R, P2G and P2B in the pixel P2-2 adjacent to the pixel P2-1 are sequentially negative, positive, negative. Moreover, the two pixels located on the junction section of the first display segment A and the second display segment B (i.e. the pixel P1-16 and the pixel P2-1) have the same polarity. For example, the polarities of the sub-pixels P1R, P1G and P1B in the pixel P1-16 are sequentially positive, negative, positive, and the polarities of the sub-pixels P2R, P2G and P2B in the pixel P2-1 are sequentially positive, negative, positive. Similarly, the rightmost pixel P2-16 in the second display segment B and the pixel P1-1 of the first display region A connected thereto have the same polarity, i.e. the polarities of the sub-pixels P2R, P2G and P2B in the pixel P2-16 and the polarities of the sub-pixels P1R, P1G and P1B in the pixel P1-1 are all sequentially negative, positive, negative.

In this way, by using the timing controller 126 to control the gate driver 122, the source driver 124 to drive the pixels corresponding to each of the scan lines on the display panel 102 in the manner of the embodiment of FIG. 2, the color shift phenomenon and the crosstalk phenomenon of the display image are effectively avoided, so as to improve the display quality of the liquid crystal display panel 102. Generally, when the display apparatus is tested in factory before shipment, DMW software is generally used to test a display effect of the display apparatus, and by driving the display panel according to the driving method of the aforementioned embodiment, the display panel may correctly display test patterns in a database of the DMW software without the problem or color shift or crosstalk.

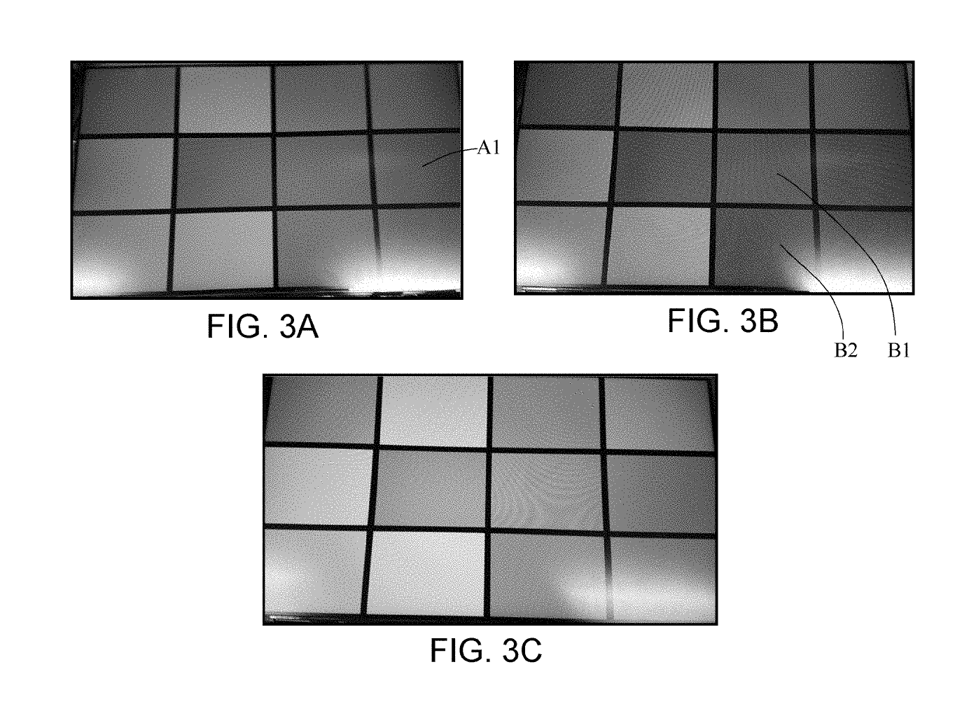

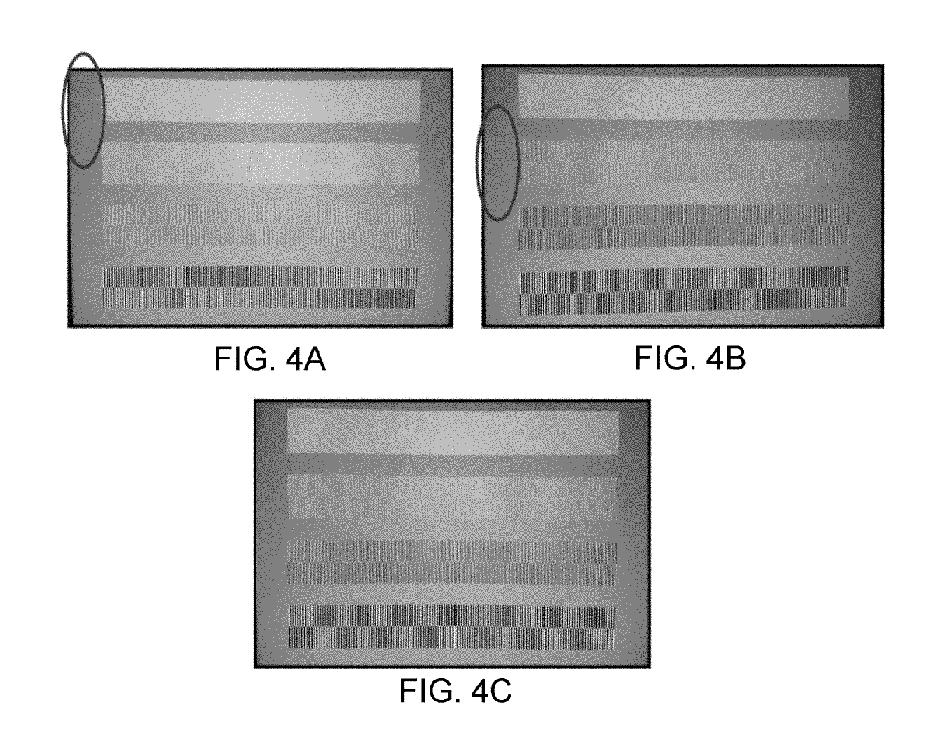

For example, FIG. 3A-FIG. 3C are image display diagrams of testing the display apparatus by using test patterns of DMW2-47, and FIG. 4A-FIG. 4C are image display diagrams of testing the display apparatus by using test patterns of DMW10-47. FIG. 3A and FIG. 4A are image display diagrams of driving the display panel by using a driving method of 1V inversion, FIG. 3B and FIG. 4B are image display diagrams of driving the display panel by using a driving method of 2V+1 inversion, FIG. 3C and

FIG. 4C are image display diagrams of driving the display panel by using the driving method of the aforementioned embodiment. The driving method of 1V inversion is to make the adjacent pixels on the scan line to have the opposite polarities, and the driving method of 2V+1 inversion is to divide the pixel region on the scan line into a plurality of display segments, where each of the display segments includes two pixels with opposite polarities, and the pixels located at a junction section of two adjacent display segments have the same polarity. According to FIG. 3A-3C, it is known that by using the driving method of 1V inversion to drive the display panel, the display image has a color shift phenomenon of shifting to green (shown as a display region A1), and by using the driving method of 2V+1 inversion to drive the display panel, the display image has the color shift phenomenon of shifting to green (shown as a display region B1, B2), and by using the driving method of the aforementioned embodiment to drive the display panel, the color shift phenomenon is effectively mitigated. Moreover, as shown in FIG. 4A-4C, by using the driving methods of 1V inversion or 2V+1 inversion to drive the display panel, the display images all have the crosstalk phenomenon (at places encircled by ellipses), though by using the driving method of the aforementioned embodiment to drive the display panel, the crosstalk phenomenon is effectively mitigated.

It should be noted that the polarity inversion driving method of the aforementioned embodiments is not limited to use the dot inversion or column inversion, and the spirit of the disclosure is met as long as the adjacent pixels in the first display segment and the second display segment have opposite polarities, and two pixels located on the junction section of the adjacent first display segment and second display segment have the same polarity. Moreover, the number of pixels in the first display segment or in the second display segment is not limited to 16 pixels, and in some embodiments, the number of pixels in the first display segment or in the second display segment may also be increased/decreased, for example, the first display segment and the second display segment respectively have 16×n pixels, where n is a positive integer.

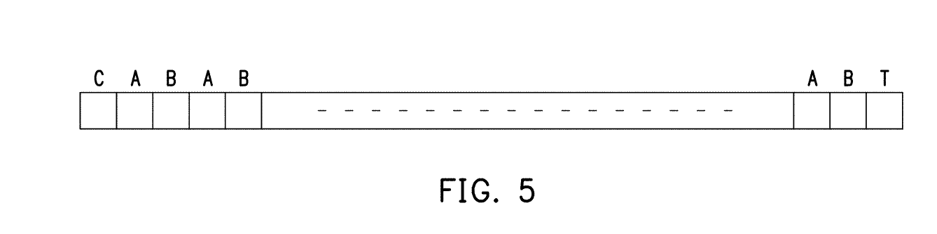

Moreover, in some embodiments, one scan line may also include two display segments with the number of pixels different to the number of pixels included in the aforementioned first display segment and the second display segment. For example, FIG. 5 is an example of polarities of the corresponding pixels when a scan line on the display panel is driven according to another embodiment of the disclosure. In the present embodiment, the pixel region on the scan line is divided into a tail display segment T, a plurality of first display segments A, a plurality of second display segments B and a third display segment C, where the tail display segment T and the third display segment C are located at two ends of the scan line, the first display segments A and the second display segments B are located between the tail display segment T and the third display segment C, and the first display segments A and the second display segments B other than the tail display segment T and the third display segment C are alternately arranged on the scan line. The number of the pixels included in the third display segment C or the tail display segment T may be different to the number of the pixels included in each of the first display segments A and each of the second display segments B, though a sum of the pixels included in the third display segment C and the tail display segment T is equal to a sum of the pixels included in one first display segment A and one second display segment B. For example, the third display segment C may include 17 pixels, and the tail display segment T includes 15 pixels, and the first display segment A and the second display segment B respectively includes 16 pixels. Moreover, when the scan line is driven, the adjacent pixels in the tail display segment, each of first display segments, each of the second display segments and the third display segment have opposite polarities, and two pixels located on a junction section of the adjacent first display segment and second display segment have the same polarity, and two pixels located on the junction section of the adjacent third display segment C or tail display segment T and first display segment or second display segment are not necessary to have the same polarity.

It should be noted that in some embodiments, the third display segment C may be not located at the end of the scan line as that shown in the embodiment of FIG. 5, and the third display segment C may also be located between any two display segments.

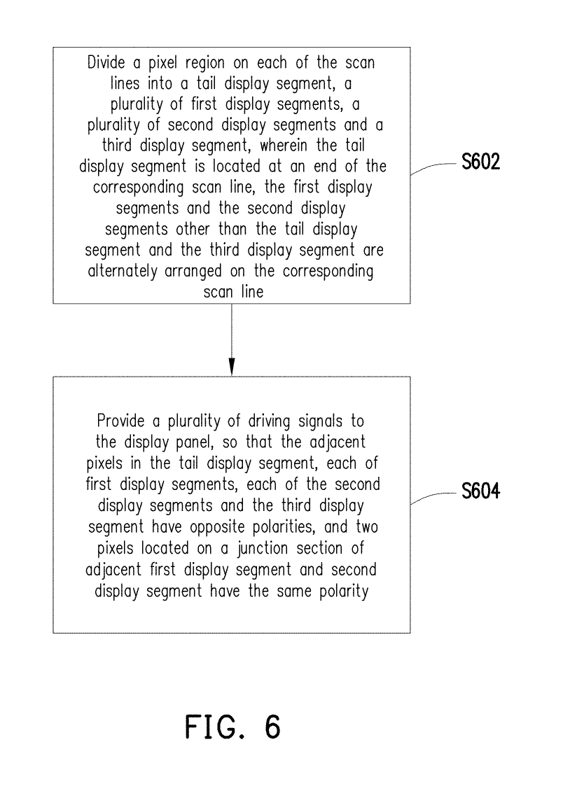

FIG. 6 is a flowchart illustrating a driving method of a display panel according to an embodiment of the disclosure. Referring to FIG. 6, according to the above embodiments, it is known that the driving method of the display panel may include following steps. First, a pixel region on each of the scan lines is divided into a tail display segment, a plurality of first display segments, a plurality of second display segments and a third display segment, where the tail display segment is located at an end of the corresponding scan line, and the first display segments and the second display segments other than the tail display segment and the third display segment are alternately arranged on the corresponding scan line (step S602), and each of the first display segments and each of the second display segments respectively includes 16 pixels, though the disclosure is not limited thereto. Moreover, a sum of sub-pixels included in the tail display segment and the third display segment is equal to a sum of sub-pixels included in one first display segment and one second display segment. In some embodiments, the numbers of the sub-pixels included in the tail display segment, each of the first display segments, each of the second display segments and the third display segment are the same. Then, a plurality of driving signals is provided to the display panel, so that the adjacent pixels in the tail display segment, each of first display segments, each of the second display segments and the third display segment have opposite polarities, and two pixels located on a junction section of adjacent first display segment and second display segment have the same polarity (step S604). Each of the pixels, for example, includes three sub-pixels, and the adjacent sub-pixels have opposite polarities, and on each of the scan line, the number of the first display segments is equal to the number of the second display segments.

Moreover, in another embodiment, a difference with the aforementioned embodiment is that the sum of the sub-pixels included in the third display segment C and the tail display segment T may be not equal to the sum of the sub-pixels included in one first display segment A and one second display segment B, though the number of the sub-pixels with the positive polarity included in the third display segment C and the tail display segment T is equal to the number of the sub-pixels with the negative polarity included in the third display segment C and the tail display segment T.

In summary, the display driver of the embodiment of the disclosure is adapted to drive the display panel so that the adjacent pixels in each of first display segments and each of the second display segments have opposite polarities, and two pixels located on a junction section of adjacent first display segment and second display segment have the same polarity. In this way, the color shift and crosstalk phenomenon occurred in the display image is effectively avoided, and the display quality of the liquid crystal display panel is improved.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A display apparatus, comprising:
a display panel, having a plurality of scan lines, a plurality of data lines and a plurality of pixels arranged in an array, and a pixel region on each of the scan lines being divided into a tail display segment, a plurality of first display segments, a plurality of second display segments and a third display segment, wherein the tail display segment is located at an end of the corresponding scan line, the first display segments and the second display segments other than the tail display segment and the third display segment are alternately arranged on the corresponding scan line; and
a display driver, coupled to the display panel, and providing a plurality of driving signals to the display panel, so that adjacent pixels in the tail display segment, each of the first display segments, each of the second display segments and the third display segment have opposite polarities, and two pixels located on a junction section of adjacent first display segment and second display segment have the same polarity.

2. The display apparatus according to claim 1, wherein each of the pixels comprises three sub-pixels, and the adjacent sub-pixels have opposite polarities.

3. The display apparatus according to claim 2, wherein a sum of the sub-pixels included in the tail display segment and the third display segment is equal to a sum of the sub-pixels included in one first display segment and one second display segment.

4. The display apparatus according to claim 3, wherein the numbers of the sub-pixels included in the tail display segment, each of the first display segments, each of the second display segments and the third display segment are the same.

5. The display apparatus according to claim 1, wherein on each of the scan lines, the number of the first display segments is equal to the number of the second display segments.

6. The display apparatus according to claim 1, wherein the numbers of the sub-pixels included in each of the first display segments and each of the second display segments are the same.

7. A driving method of a display panel, wherein the display panel has a plurality of scan lines, a plurality of data lines and a plurality of pixels arranged in an array, the driving method of the display panel comprising:
dividing a pixel region on each of the scan lines into a tail display segment, a plurality of first display segments, a plurality of second display segments and a third display segment, wherein the tail display segment is located at an end of the corresponding scan line, the first display segments and the second display segments other than the tail display segment and the third display segment are alternately arranged on the corresponding scan line; and
providing a plurality of driving signals to the display panel, so that adjacent pixels in the tail display segment, each of the first display segments, each of the second display segments and the third display segment have opposite polarities, and two pixels located on a junction section of adjacent first display segment and second display segment have the same polarity.

8. The driving method of the display panel according to claim 7, wherein each of the pixels comprises three sub-pixels, and the adjacent sub-pixels have opposite polarities.

9. The driving method of the display panel according to claim 8, wherein a sum of the sub-pixels included in the tail display segment and the third display segment is equal to a sum of the sub-pixels included in one first display segment and one second display segment.

10. The driving method of the display panel according to claim 9, wherein the numbers of the sub-pixels included in the tail display segment, each of the first display segments, each of the second display segments and the third display segment are the same.
